(19) United States
(12) Patent Application Publication
(10) Pub. No.: US 2010/0189639 A1
(43) Pub. Date: Jul. 29, 2010

(54) REFORMER, AND METHOD FOR REACTING FUEL AND OXIDANT TO GASEOUS REFORMATE

(75) Inventor: Stefan Kah, Neubrandenburg (DE)

Correspondence Address: DICKINSON WRIGHT PLLC, 1875 Eye Street, NW, Suite 1200, WASHINGTON, DC, 20006, US

(73) Assignee: ENERDAY GMBH, Stockdorf (DE)

(21) Appl. No.: 12/305,790

(22) PCT Filed: Jun. 12, 2007
(86) PCT No.: PCT/DE2007/001038

§ 371 Date: Mar. 23, 2009

(30) Foreign Application Priority Data
Jul. 17, 2006 (DE) 10 2006 032 956.2

(51) Int. Cl. C01B 3/26; B01J 8/02

(52) U.S. Cl. 423/651; 422/189

(57) ABSTRACT

The invention relates to a reformer for reacting fuel and oxidant to a gaseous reformate, comprising an oxidation zone, an evaporation zone and a zone for catalytic H₂ generation, the oxidation zone being capable of receiving a supply of a gaseous mixture of fuel and oxidant for oxidation in generating an oxidant-containing exhaust gas, the evaporation zone being capable of receiving a supply of fuel and an evaporator gas for generating an evaporator gas mixture containing fuel, and the zone for catalytic H₂ generation being capable of receiving a supply of an ignitable reforming gas mixture containing evaporated fuel and an oxidant-containing exhaust gas to generate the gaseous reformate. To diminish the risk of self-ignition in the evaporation zone it is proposed that to generate the reforming gas mixture and to feed it into the zone for catalytic H₂ generation mix and feeder means are inserted upstream of an input to the zone for catalytic H₂ generation, said mix and feeder means, on the one hand, receiving a supply of oxidant-containing exhaust gas from the oxidation zone and, on the other, an evaporator gas mixture containing fuel from the evaporation zone, means for returning reformate generated in the zone for catalytic H₂ generation as evaporator gas to the evaporation zone being provided. The aspect in accordance with the invention achieves that no ignitable gas mixture is formed in the evaporation zone. The invention relates furthermore to a corresponding method for reacting fuel and oxidant to a gaseous reformate.

The invention relates to a reformer for reacting fuel and oxidant to a gaseous reformate, comprising an oxidation zone, an evaporation zone and a zone for catalytic H₂ generation, the oxidation zone being capable of receiving a supply of a gaseous mixture of fuel and oxidant for oxidation in generating an oxidant-containing exhaust gas, the evaporation zone being capable of receiving a supply of fuel and an evaporator gas for generating an evaporator gas mixture containing fuel, and the zone for catalytic H₂ generation being capable of receiving a supply of an ignitable reforming gas mixture containing evaporated fuel and an oxidant-containing exhaust gas to generate the gaseous reformate.

The invention relates furthermore to a method for reacting fuel and oxidant to a gaseous reformate comprising oxidizing in an oxidation zone a fuel mixed with a gaseous oxidant in generating an oxidant-containing exhaust gas, evaporating in an evaporation zone fuel with an evaporator gas into an evaporator gas mixture containing fuel and reforming in a zone for catalytic H₂ generation a reforming gas mixture containing an evaporated fuel and an oxidant-containing exhaust gas to generate the gaseous reformate.

Generic reformers and generic methods as known from DE 103 59 205 A1 have a wealth of fields of application, they, however, serving particularly to supply a fuel cell with a hydrogen-rich gas mixture from which electrical energy can then be generated on the basis of electrochemical reactions. Such fuel cells find application for example in the automotive field as auxiliary power units (APUs).

The known method substantially represents a three-stage process. In a first stage an oxidation zone receives a supply of fuel containing hydrocarbons, e.g. diesel, and is oxidized, i.e. combustioned in an exothermic reaction, resulting in an exhaust gas typically 800 to 1000° C. hot which with a sufficient initial oxygen concentration of the combustion air still contains oxidant, i.e. typically oxygen.

The hot exhaust gas containing oxygen is then introduced into an evaporation zone in which further fuel is dispensed. When liquid fuel is used, as is typical, this evaporates due to the high temperature, forming an ignitable mixture of fuel and exhaust gas which is then reformed into a hydrogen-rich gas, the synthesized gas or reformate in a zone for catalytic H₂ generation, typically in making use of a partial oxidation catalyst in what is known as a catalytic partial oxidation (CPDX) process. The reformate is subsequently supplied to a fuel cell where it together with oxygen in forming water in accordance with known principles is employed to generate electrical energy.

The drawback in this known process is that in the evaporation zone a ignitable mixture is formed which harbors the risk of spontaneous self-ignition which can result in the downstream catalyst becoming sooted up and the necessity of having to interrupt the process. Spontaneous self-ignition is currently counteracted by highly accurate control of the ratio of combustioned to evaporated fuel, resulting in the parameter range, in which stable operation of the reformer is possible, being greatly restricted.

The invention is based on the object of making available a reformer and a method of reacting fuel and oxidant to reformate in which the aforementioned drawbacks are overcome, at least in part, and in which particularly the breadth of variation of the operation parameters permitting stable operation is widened.

This object is achieved by the features of the independent claims.

Advantageous embodiments of the invention are recited in the dependent claims.

The invention is based on the generic reformer in that to generate the reforming gas mixture and to feed it into the zone for catalytic H₂ generation mix and feeder means are inserted upstream of an input to the zone for catalytic H₂ generation the mix and feeder means, on the one hand, being capable to receive a supply of oxidant-containing exhaust gas from the oxidation zone and, on the other, an evaporator gas mixture containing fuel from the evaporation zone, wherein means for returning reformate generated in the zone for catalytic H₂ generation as evaporator gas to the evaporation zone being provided.

The invention is based on the generic method in that to generate the reforming gas mixture it comprises: mixing the oxidant-containing exhaust gas for generating the reforming gas mixture with an evaporator gas mixture and feeding the mix into the zone for catalytic H₂ generation and the reformate generated in the zone for catalytic H₂ generation being returned as evaporator gas to the evaporation zone.

The effects and advantages of the reformer in accordance with the invention and of the method in accordance with the invention will now be discussed in common.

Contrary to prior art it is provided for in the scope of the invention that the hot exhaust gas from the oxidation zone is now not used as evaporator gas in the evaporation zone, but instead the reformate generated in the reforming zone is returned as evaporator gas to the evaporation zone where it is enriched with fuel which, because of the high reformate temperature, evaporates.

Now, due to the lack of an oxidant, hydrogenated reformate no longer forms together with the evaporated fuel an ignitable mixture, banning the risk of spontaneous self-ignition in the evaporation zone. An ignitable mixture is first generated by the downstream mix and feeder means in which by mixing the fuel-enriched reformate from the evaporation zone and the oxidant-containing exhaust gas from the oxidation zone an ignitable reforming gas mixture is now formed and supplied to the zone for catalytic H₂ generation.

A further advantage of the invention is that the hydrogen contained in the reformate used as evaporator gas now reduces sooting up in evaporation of the enrichment fuel. Evaporation of the fuel is typically carrier-gas controlled so that even low evaporation temperatures—significantly below the boiling point of the components contained in the fuel—are sufficient to evaporate the fuel. This reduction in temperature now also results in non-aggressive evaporation of the fuel with low soot formation.

The mix and feeder means are favourably engineered as an injector, this having, for one thing, the advantage that no large-volume range containing an ignitable mixture is formed with its risk of spontaneous self-ignition. For another, feeding the ignitable mixture into the zone for catalytic H₂ generation at high speed safely excludes flashback.

The injector is powered to advantage by exhaust gas, i.e. as a source of energy for mixing and feeding the ignitable reforming gas mixture the kinetic energy of the oxidant-containing exhaust gas from the oxidation zone is now exploited. By correctly setting the mechanical properties of the injector the ratio in mixing the oxidant-containing exhaust gas and the enriched evaporator gas can now be lastingly optimized without continual active control of the components being necessary. The injector may operate for example on the principle of a Venturi nozzle.

As mentioned, the invention results in the advantage that evaporation of the enrichment fuel in the evaporation zone can now take place at relatively low temperatures. On the other hand, the reformate generated in the zone for catalytic H₂ generation has typically a very high temperature. This is why in one advantageous further embodiment of the invention it is now provided for that heat is drawn off from the reformate on return. This is achievable, for example, in that the return means comprise heat exchanger means for cooling the returned reformate. Preferably the heat exchanger means can be activated and deactivated as required. The resulting recuperated heat can be made use of, for example, to preheat a process air stream in a downstream fuel cell system, it also being conceivable to make use of it for preheating fuel as a source of heat in the zone for catalytic H₂ generation, in an afterburner or in other components of the system.

In addition to returning the reformate to the evaporation zone as provided for in accordance with the invention, the reformate generated can be branched off directly into the zone for catalytic H₂ generation, i.e. in making use of the return means in the region of the zone for catalytic H₂ generation. For this purpose a gas sniffer can be employed in the zone for catalytic H₂ generation ensuring a high return rate of the gas stream to be recycled. On the other hand, it is also possible to make use of the return means in a zone downstream of the zone for catalytic H₂ generation, for instance immediately following a fuel cell downstream of the zone for catalytic H₂ generation. As a result of the electrochemical oxidation in the fuel cell there is an increase in the oxygen concentration and thus of the O/C ratio in the returned gas flow and thus also in the catalyst which is decisive in influencing sooting up. From a thermodynamic point of view, sooting up becomes less with increasing O/C ratio so that in this respect making the return following the fuel cell may be of advantage as compared to following the reformer when kinetic effects play a minor role in sooting up.

Typically, the hydrogen supplied to a fuel cell is not totally reacted with oxygen into water, the exhaust gas of the fuel cell anode thus containing, as a rule, a useful concentration of hydrogen.

This is why in one special embodiment of the invention it is provided for to return this anode exhaust gas and exhaust gas to the evaporation zone, although, of course, combinations of the aforementioned return possibilities can be realized just as well.

In one particularly favourably further embodiment of the invention it is provided for that the evaporator gas mixture is cleaned from contaminates prior to it being mixed with the oxidant-containing exhaust gas. For this purpose, gas cleaners are provided preferably between the mixer and feeder means, i.e. in particular between the injector and the evaporation zone for removing contaminates from the evaporator gas mixture. In this arrangement this may involve a catalytic protection device, known as such, which absorbs the catalytic poisons such as e.g. metals or soot precursors contained in the evaporator gas in rendering them harmless partially by reaction with the hydrogen contained in the reformate.

As explained, the present invention relates to a reformer and a method of generating a reformate. It is to be noted, however, that the present invention also yields advantages in an operation mode of the reformer in which the reformate is not generated directly. In this mode, termed regeneration mode herein fuel enrichment in the evaporation zone is deactivated, so that no reformate is formed in the zone for catalytic H₂ generation. Instead, combustion exhaust gas streams from the oxidation zone through the zone for catalytic H₂ generation. In the regeneration mode this gas is supplied via the return means to the evaporation zone and mixed via the mix and feeder means with “fresh” combustion exhaust gas before being returned to the zone for catalytic H₂ generation. By recycling the exhaust gas in this way any soot deposits having formed in the evaporation zone and/or in a downstream gas cleaner are burnt off in thereby regenerating the elements concerned.

Preferred embodiments of the invention will now be detailed with reference to the attached drawings by way of example, in which:

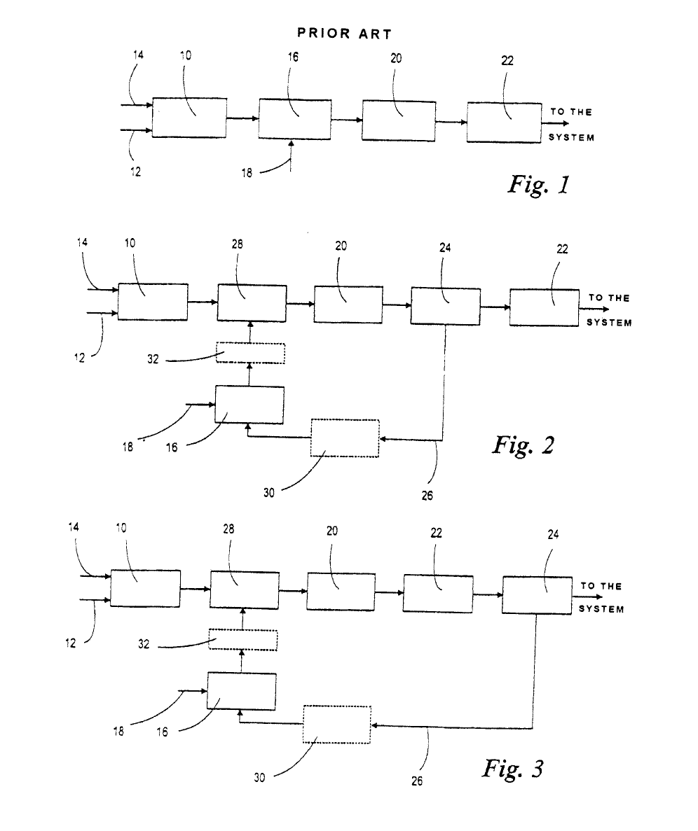

FIG. 1 is a diagrammatic representation of the structure of a prior art reformer;

FIG. 2 is a diagrammatic representation of the structure of a reformer in accordance with the invention comprising a plurality of optional auxiliary elements; and

FIG. 3 is a diagrammatic representation of the structure of an alternative embodiment of the reformer in accordance with the invention.

Referring now to FIG. 1 there is illustrated a diagrammatic representation of the structure of a prior art reformer. In a burner 10 comprising an oxidation zone, air is supplied via a first feeder conduit 12 and liquid fuel, e.g. diesel via a second feeder conduit 14. The burner 10 comprises typically a mixing zone (not shown) for forming an ignitable gas mixture of the combustion air and fuel, this mixing zone being provided upstream of the actual oxidation zone. The exhaust gas resulting from combustion in the burner 10 and which also contains oxidant non-reacted during combustion is fed into an evaporator 16 where it serves as evaporator gas. The evaporator 16 comprises a feeder conduit 18 for further liquid fuel with which the evaporator gas is enriched. Due to the high temperatures the liquid fuel supplied via the feeder conduit 18 evaporates. The enriched gas, i.e. the mix of evaporator gas and evaporated fuel forms an ignitable reformer gas mixture which is fed into the downstream zone 20 for catalytic H₂ generation comprising in particular a CPDX catalyst. In the zone 20 for catalytic H₂ generation hydrogenated reformate is generated catalytically which can be supplied to a downstream fuel cell 22. The exhaust gas of the fuel cell is suitable treated, depending on the structure of the system, indicated in FIG. 1 by the discharge “to system”.

Referring now to FIG. 2 there is illustrated a diagrammatic representation of a reformer in accordance with the invention in which like components are identified by like reference numerals as in FIG. 1. In the embodiment as shown in FIG. 2 a gas sniffer 24 is inserted upstream of the fuel cell. It is to be noted in the diagrammatic representation as shown in FIG. 2 that the elements shown are not necessarily subject matter elements but substantially the function elements. Thus, the gas sniffer 24 may also be integrated in the zone 20 for catalytic H₂ generation. The function of the gas sniffer 24 is to return part of the hydrogenated reformate generated in the zone 20 for catalytic H₂ generation via the return conduit 26 to the evaporator 16. In other words, unlike prior art, used as the evaporator gas in the evaporator 16 is not the exhaust gas from the burner 10 but the reformate returned via the return conduit 26.

The exhaust gas from the burner 10 as well as the enriched evaporator gas from the evaporator 16 are supplied together to an injector 28 which is preferably engineered as a nozzle powered by the exhaust gas from the burner 10. It is in the injector 28 that the two gas streams are mixed and the resulting ignitable mixture is fed into the zone 20 for catalytic H₂ generation.

In the embodiment as shown in FIG. 2 an optional heat exchanger 30 is integrated in the return conduit 26, as is indicated by the broken line in FIG. 2 to characterize its optional character. The heat exchanger 30 can be preferably adapted to be activated and deactivated as required and serves particularly to cool the reformate returned via the return conduit 26. The heat exchanger 30 can be used as an active temperature controller to maintain the temperature in the evaporator 16 in an optimum range. Furthermore, the heat exchanger can be used to set the temperature in the evaporator so that the ignition temperature of the soot is attained in initiating soot oxidation to thus desoot the evaporator, in other words to regenerate it.

As a further option in the embodiment as shown in FIG. 2 a gas cleaner 32 may be provided disposed between the evaporator 16 and the injector 28. This gas cleaner 32 serves to remove so-called catalytic poisons from the gas stream respectively to convert harmful compounds (soot precursors) into safe compounds. This conversion can be done e.g. by the returned hydrogen, e.g. by hydrogenation of acetylene, ethylene, polycyclic aromatic compounds.

Referring now to FIG. 3 there is illustrated substantially the same structure as shown in FIG. 2, like components again being identified by like reference numerals. However, unlike FIG. 2, FIG. 3 shows how the gas sniffer 24 is now arranged functionally downstream of the fuel cell 22, this variant of the invention permitting recycling of the anode exhaust gas of the fuel cell 22.

It is, of course, to be understood that the embodiments as shown in the FIGs. and as discussed in the particular description are intended merely as illustrative aspects of the invention, the person skilled in the art having a broad spectrum of possible variations at his disposal. For instance, it is just as possible to combine the embodiments as shown in FIG. 2 and FIG. 3 such that the evaporator 16 receives both a supply of reformate from the zone 20 for catalytic H₂ generation and fuel cell exhaust gas from the fuel cell 22 as evaporator gas.

It is understood that the features of the invention as disclosed in the above description, in the drawings and as claimed may be essential to achieving the invention both by themselves or in any combination.

### LIST OF REFERENCE NUMERALS

10 burner
12 air feeder conduit
14 fuel feeder conduit
16 evaporator
18 fuel feeder conduit
20 zone 20 for catalytic H₂ generation
22 fuel cell
24 gas sniffer
26 return conduit
28 injector
30 heat exchanger
32 gas cleaner

1. A reformer for reacting fuel and oxidant to a gaseous reformate, comprising an oxidation zone, an evaporation zone and a zone for catalytic H₂ generation, the oxidation zone being capable of receiving a supply of a gaseous mixture of fuel and oxidant for oxidation in generating an oxidant-containing exhaust gas, the evaporation zone being capable of receiving a supply of fuel and an evaporator gas for generating an evaporator gas mixture containing fuel, and the zone for catalytic H₂ generation being capable of receiving a supply of an ignitable reforming gas mixture containing evaporated fuel and an oxidant-containing exhaust gas to generate the gaseous reformate, wherein to generate the reforming gas mixture and to feed it into the zone for catalytic H₂ generation mix and feeder means are inserted upstream of an input to the zone for catalytic H₂ generation the mix and feeder means, on the one hand, being capable to receive a supply of oxidant-containing exhaust gas from the oxidation zone and, on the other, an evaporator gas mixture containing fuel from the evaporation zone, wherein means for returning reformate generated in the zone for catalytic H₂ generation as evaporator gas to the evaporation zone being provided.

2. The reformer of claim 1, wherein the mix and feeder means are engineered as an injector.

3. The reformer of claim 2, wherein the injector is powered by the feed of oxidant-containing exhaust gas.

4. The reformer of claim 1, wherein the return means comprise heat exchanger means for cooling the returned reformate respectively to initiate start of soot oxidation in the evaporator.

5. The reformer of claim 4, wherein the heat exchanger means are adapted to be activated and deactivated as required.

6. The reformer of claim 1, wherein the return means for discharging reformate from the zone for catalytic H₂ generation are active in the zone for catalytic H₂ generation.

7. The reformer of claim 1, wherein the return means for discharging reformate are active in a zone downstream of the zone for catalytic H₂ generation.

8. The reformer of claim 7, wherein the return means for discharging reformate are active at an anode exhaust gas conduit of a fuel cell downstream of the zone for catalytic H₂ generation.

9. The reformer of claim 1, wherein the mixer and feeder means and the evaporation zone is a gas cleaner for removing contaminates from the evaporator gas mixture.

10. A method for reacting fuel and oxidant to a gaseous reformate, comprising: oxidizing a fuel mixed with a gaseous oxidant in a oxidation zone in generating an oxidant-containing exhaust gas, evaporating fuel with an evaporator gas to an evaporator gas mixture containing fuel in an evaporation zone, and, for generating the gaseous reformate, reforming a reforming gas mixture containing an evaporated fuel and an oxidant-containing exhaust gas in a zone for catalytic H₂ generation, wherein the oxidant-containing exhaust gas is mixed with evaporator gas mixture containing fuel and is fed to the zone for catalytic H₂ generation to generate the reforming gas mixture wherein reformate generated in the zone for catalytic H₂ generation is returned as evaporator gas to the evaporation zone.

11. The method of claim 10, wherein the heat is drawn off from the returned reformate during return.

12. The method of claim 10, wherein the evaporator gas mixture is cleaned from contaminates before being mixed with the oxidant-containing exhaust gas.
